(19) United States
(12) Patent Application Publication
(10) Pub. No.: US 2014/0379521 A1
(43) Pub. Date: Dec. 25, 2014

(54) ACTIVITY-BASED PERSONAL PROFILE INFERENCE

(71) Applicant: Microsoft Corporation, Redmond, WA (US)

(72) Inventors: Margaret JoAnn Novotny, Greenbrae, CA (US); Blaise Aguera y Arcas, Seattle, WA (US); Benny Schlesinger, Ramat Hasharon (IL); Hen Fitoussi, Tel-Aviv (IL); Alexander Cristoff, Kirkland, WA (US); Christina Summer Chen, Bellevue, WA (US)

(21) Appl. No.: 14/467,638

(22) Filed: Aug. 25, 2014

Related U.S. Application Data
(63) Continuation of application No. 13/924,052, filed on Jun. 21, 2013, now abandoned.

(51) Int. Cl. G06N 5/04; G06N 99/00; G06Q 30/06; G06N 5/02

(52) U.S. Cl. CPC G06N 5/048; G06N 5/02; G06N 99/005; G06Q 30/0631
USPC 705/26.7; 706/47; 706/14; 706/52

(57) ABSTRACT

The aggregation of facts from various sources about an individual may produce an individual profile that may inform personalized services. However, a compilation of facts may be supplemented by monitoring activities of the individual and formulating inferences regarding the individual's individual details, and the confidence of such inferences. Accordingly, a device may compare the detected activities with a behavioral rule set indicating correlations between activities and inferred individual details (e.g., frequently spent weekday evenings and morning departures from a residence imply that the residence is the individual's home; frequent bicycling to work, chosen over other available modes of transportation, implies that the individual is a bicycling enthusiast) to add inferred individual details to the individual profile. Continued monitoring may enable updating based on changes to the individual details. Multiple profiles may be synchronized while respecting the individual's privacy, obtaining the individual's consent to share information, and automatically resolving information conflicts.

### CROSS-REFERENCE TO RELATED APPLICATIONS

The present application is a continuation of and claims priority to U.S. patent application Ser. No. 13/924,052, filed Jun. 21, 2013 and titled “ACTIVITY-BASED PERSONAL PROFILE INFERENCE,” the entirety of which is incorporated by reference as if fully rewritten herein.

### BACKGROUND

Within the field of computing, many scenarios involve generation of an individual profile compiled from facts assembled from a set of data signals and sources. For example, an individual may input facts about the individual's life and preferences to a database. As a second example, a history of purchases through a commerce site may be examined to identify items that the individual owns. As a third example, a social profile of the individual provided by a social network may be examined to extract facts about the individual. The facts of the individual profile maybe inform various services, such as the recommendation of products that may be of interest to the individual.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the assembly of an individual profile from a collected set of facts may provide useful information, additional information may be derived from inferences about activities of the individual. As a first such example, a device having a global positioning system (GPS) receiver that is configured to monitor the location of the individual over time may provide factual information about the individual's travel history, but may also enable inferences of individual details of the individual, the significance of the visited locations to the individual. For example, a location to which the individual often travels on weekday evenings and departs on weekday mornings may be inferred as the individual's residence, and a location where the individual regularly visits during consistent hours on weekdays may be inferred as the individual's workplace. As a second such example, a device having a physiological sensor may track the physical activities of the individual (e.g., detecting when the individual engages in bicycling), and depending on the contextual details of the bicycling activity, the device may infer various individual details of the individual, such as whether the individual is a bicycle enthusiast (e.g., choosing to bicycle long distances when other modes of transportation are available), a bicycle commuter (e.g., choosing to bicycle from home to a workplace and back), or utility bicyclist (e.g., bicycling for transportation only when other modes of transportation are unavailable, such as when the individual's automobile is unavailable).

In accordance with these observations, the present techniques enable the generation of an individual profile of an individual based on inferences derived from the activities of the individual. These techniques involve the generation of a behavioral rule set indicating, for one or more individual details, a set of activities that are correlated with the individual details. A device that is capable of monitoring the activities of the individual may compare such activities with the behavioral rule set, and may therefore infer individual details about the individual to be assembled into the individual profile of the individual. Additionally, the inferences may be identified according to a particular confidence (e.g., a certainty of the inference based on the number, frequency, and/or strength of correlation between the activities and the inference). The device may continue evaluating the confidence of the respective inferences over time in order to verify, maintain, update, and/or correct the individual profile of the individual over time (e.g., as new information becomes available, or as the individual's individual details change). The individual profile derived from such inferences may be used in many ways, such as recommending products to the individual based on the inferred individual details; initiates social connections between the individual and individuals having similar individual details; and updating a social profile of the individual in a social network.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring an assembly of an individual profile of an individual based on an extraction of facts from a variety of sources.

FIG. 2 is an illustration of an exemplary scenario featuring a set of inferences about an individual derived from the individual's activities, resulting in a set of inferred individual details and a confidence that the individual detail currently describes the individual, in accordance with the techniques presented herein.

FIG. 3 is a component block diagram of an exemplary system configured to generate an individual profile of an individual through inferences based on the activities of the individual in accordance with the techniques presented herein.

FIG. 4 is a flow diagram of an exemplary method of generating an individual profile of an individual through inferences based on the activities of the individual in accordance with the techniques presented herein.

FIG. 5 is an illustration of an exemplary memory device storing instructions that embody one or more of the techniques presented herein.

FIG. 6 is an illustration of an exemplary behavioral rule set that may be utilized to infer individual details based on the activities of an individual in accordance with the techniques presented herein.

FIG. 7 is an illustration of an exemplary scenario featuring a merging of an inferred individual profile of an individual and a social profile of the individual in accordance with the techniques presented herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. INTRODUCTION

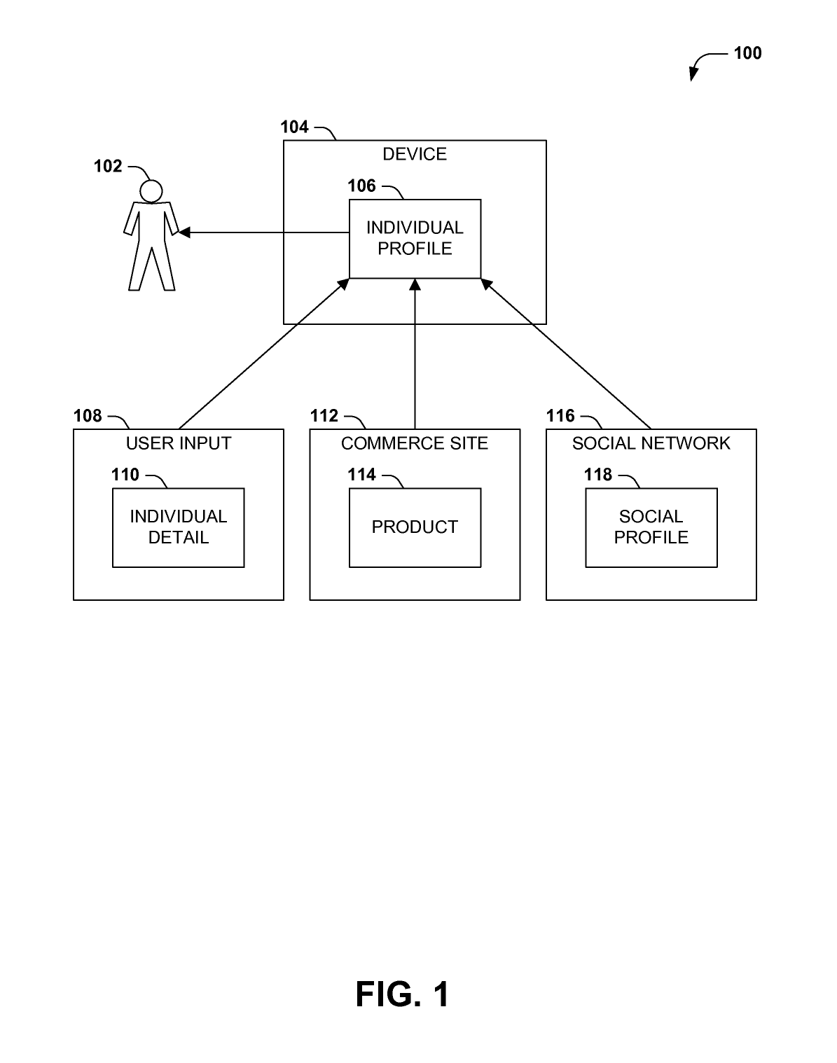

FIG. 1 presents an illustration of an exemplary scenario 100 featuring the generation of a n individual profile 106 of an individual 102 of a device 104 based on an extraction of facts from various factual sources. The device 104 may comprise, e.g., a personal computer of the individual 102, such as a workstation, laptop, or game console; a portable device of the individual 102, such as a mobile phone, tablet, personal media player, or global positioning system (GPS) navigation device; or a server providing a service utilized by the individual 102. In this exemplary scenario 100, the device 104 assembles the individual profile 106 from individual details 110 provided by the individual 102 as user input (e.g., the individual's indication of his or her name, age, and home address). As a second example, the device 104 accesses a commerce site 112 to retrieve a history of products 114 purchased by the individual 102. As a third example, the individual profile 106 may include information extracted from a social profile 118 specified by the individual 102 within a social network 116, which may include, e.g., factual statements about the individual 102 made by the individual 102 and his or her social contacts. The device 104 may utilize the individual profile 106 assembled from the publicly available facts about the individual 102 to inform various tasks, such as recommending additional products 114 to the individual 102 (e.g., if the purchase history of the individual 102 indicates a recent purchase of a bicycle, the device 104 may recommend to the individual 102 the purchase of a bicycle helmet).

### B. PRESENTED TECHNIQUES

While the assembly of individual profiles 106 of individuals 102 based on a collection of facts may inform various services and processes, the evaluation of the activities of the individual 102 may often enable the inference of individual details about the individual 102 that may significantly extend the individual profile 106.

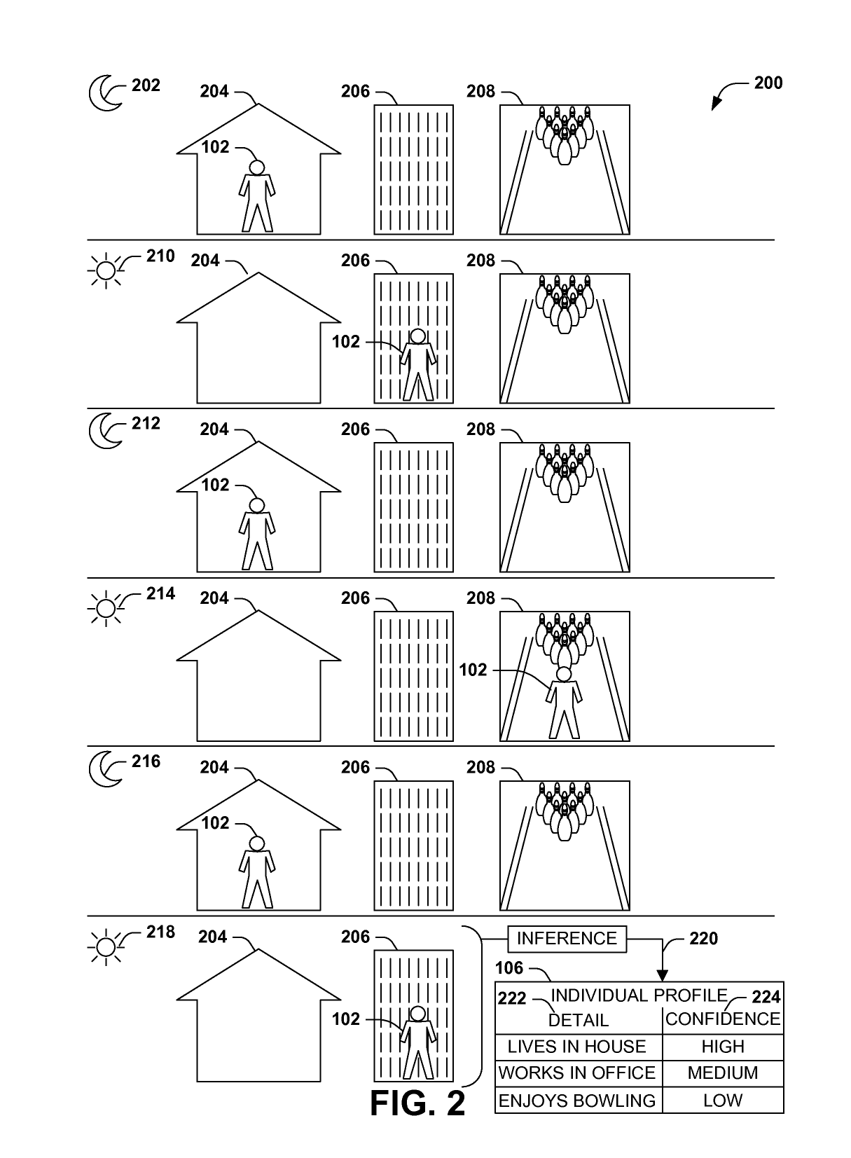

FIG. 2 presents an illustration of an exemplary scenario 200 featuring an inference 220 of individual details 222 about an individual 102 based on an evaluation of the travel of the individual 102. In this exemplary scenario, the individual 102 may often carry a location-aware device, such as a global positioning system (GPS) receiver, which may track the travel of the individual 102 over time. During an evening 202 of a first day, the individual 102 may be located at a location that the device may determine (e.g., by comparing the coordinates of the individual 102 with a location database) to be a residence 204 in a residential neighborhood. During a first day 210, the individual 102 may be detected to travel from the residence 204 to a second location comprising an office 206 in a commercial district; and during the evening 212 of the first day 210, the individual 102 may be detected to travel from the office 206 to the residence 204. During a second day 214, the individual 102 may be detected to travel from the residence 204 to a third location comprising a bowling alley 208, and, again, during the evening 216 of the third day 214, the individual 102 may be detected to return to the residence 204 from the bowling alley 208. During a fourth day 218, the individual 102 may again be detected to travel from the residence 204 to the location of the office 206.

In addition to tracking the travel history of the individual 102 through these four days, the device may also be able to perform a set of inferences 220 from the travel activities of the individual 102 to the individual details 222 of the individual 102. As a first example, the high frequency with which the individual 102 returns to the residence 204 each evening, and with which the individual 102 may support an inference 220 that the individual 102 lives in the residence 204. As a second example, the frequency with which the individual 102 visits the office 206 during the daytime (particularly if such days are coordinated with typical working hours, such as 9:00 am to 5:00 pm on weekdays) may enable an inference 220 that the individual 102 is employed, and that the office 206 is the workplace of the individual 102. As a third example, the visit of the individual 102 to the bowling alley 208 may enable an inference 220 that the individual 102 enjoys bowling. However, each inference 220 may be reached with a particular confidence 224; e.g., the confidence 224 in the inference 220 that the individual 102 lives in the residence 204 may be high, due to the regularity with which the individual 102 visits the residence 204, while the inference 220 that the individual 102 works in the office 206 may have a medium confidence 224 (due to the availability of other explanations, e.g., the individual 102 is visiting the office as a client of a professional service, and the divergence on the third day 214 to visit the bowling alley 208), and the inference 220 of the interest of the individual 102 in bowling may have a low confidence 224. In this manner, the use of the location data collected by the global positioning system (GPS) receiver may be used to infer about the individual 102 a significant number of individual details 222, and an estimation of the confidence 224 of such inferences.

In view of these observations, a device may be configured to formulate inferences about the individual 102 according to the activities of the individual 102. In particular, the inferences 220 may be reached by comparing the activities of the individual 102 with a behavioral rule set indicating the correlation of activities with particular individual details 222. For example, the behavioral rule set may indicate that regular visits to the residence 204, particularly over weekday evenings, may indicate that the individual 102 resides in the residence. By storing a behavioral rule set specifying the correlation of activities and individual details 222, as well as the confidence 224 of such correlations, a device may utilize the behavioral rule set to achieve the inferences 220 of the individual details 222 of the individual 120 in accordance with the techniques presented herein.

### C. EXEMPLARY EMBODIMENTS

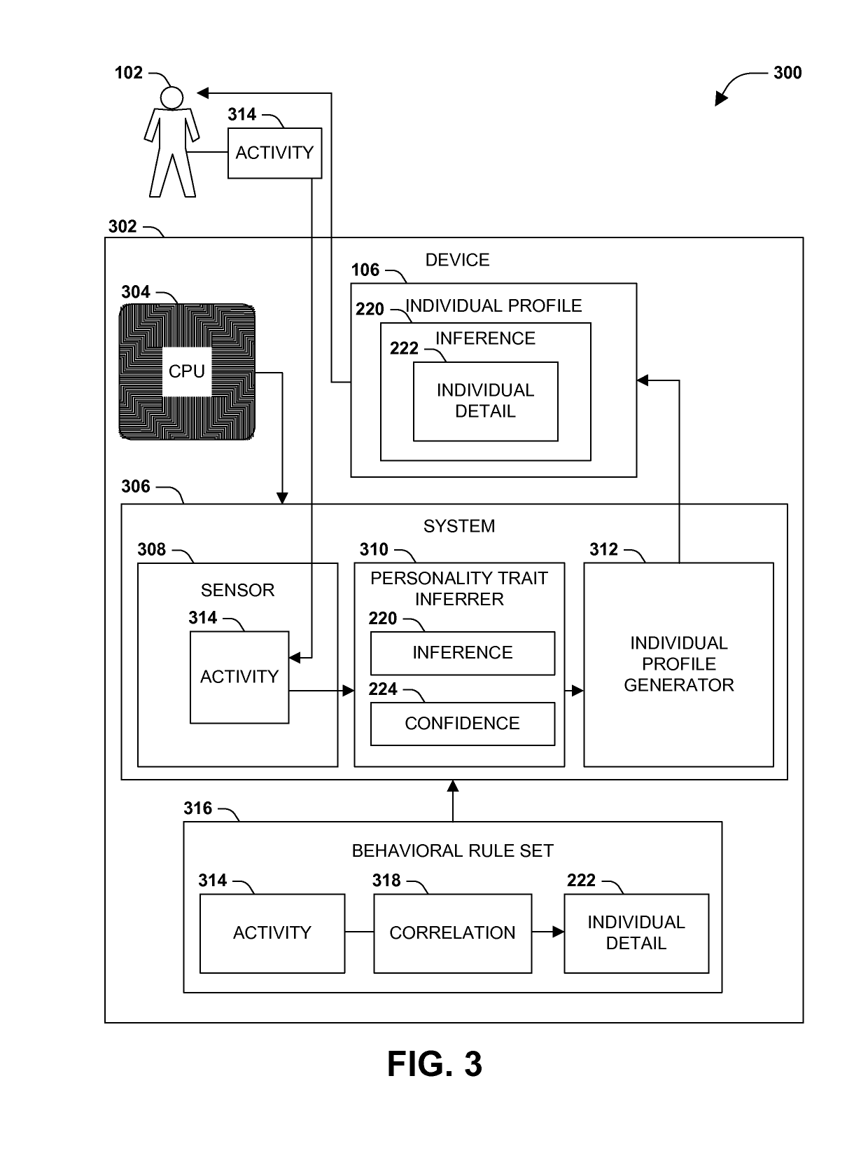

FIG. 3 presents a first exemplary embodiment of the techniques presented herein, illustrated as an exemplary scenario 300 featuring an exemplary system 306 configured to cause a device 302 to generate an individual profile 106 of an individual 102 of the device 302. The exemplary system 306 may be implemented, e.g., as a set of components respectively comprising a set of instructions stored in a memory component of a device 302 having a processor 304, where the instructions of respective components, when executed on the processor 304, cause the device 302 to perform respective portions of the techniques presented herein, such that the interoperation of the components causes the device 302 to operate according to the techniques presented herein. The exemplary system 306 includes at least one sensor 308 that detects at least one activity 314 of the individual 102 in accordance with the techniques presented herein. For example, the sensor 308 may comprise a global positioning system (GPS) receiver configured to detect geographic coordinates indicating the travel activities 314 of the individual 102. The exemplary system 306 also includes an individual detail inferrer 310 that infers at least one individual detail 222 of the individual 102 according to the at least one activity 314 and a behavioral rule set 316 indicating correlations 318 of activities 314 and individual details 222. The exemplary system 306 also comprises an individual profile generator 312 that generates the individual profile 106 of the individual 102 comprising at least one individual detail 222 inferred from the activities 314 of the individual 102 according to the behavioral rule set 316. The individual profile 106 may then be used, e.g., to provide a variety of personalized services to the individual 102 based on the inference of individual details 222, such as product recommendations of products 114, social networking, and the updating of a social profile 118. In this manner, the device 302 achieves the generation of the individual profile 106 including at least one inference 220 of an individual detail 222 in accordance with the techniques presented herein.

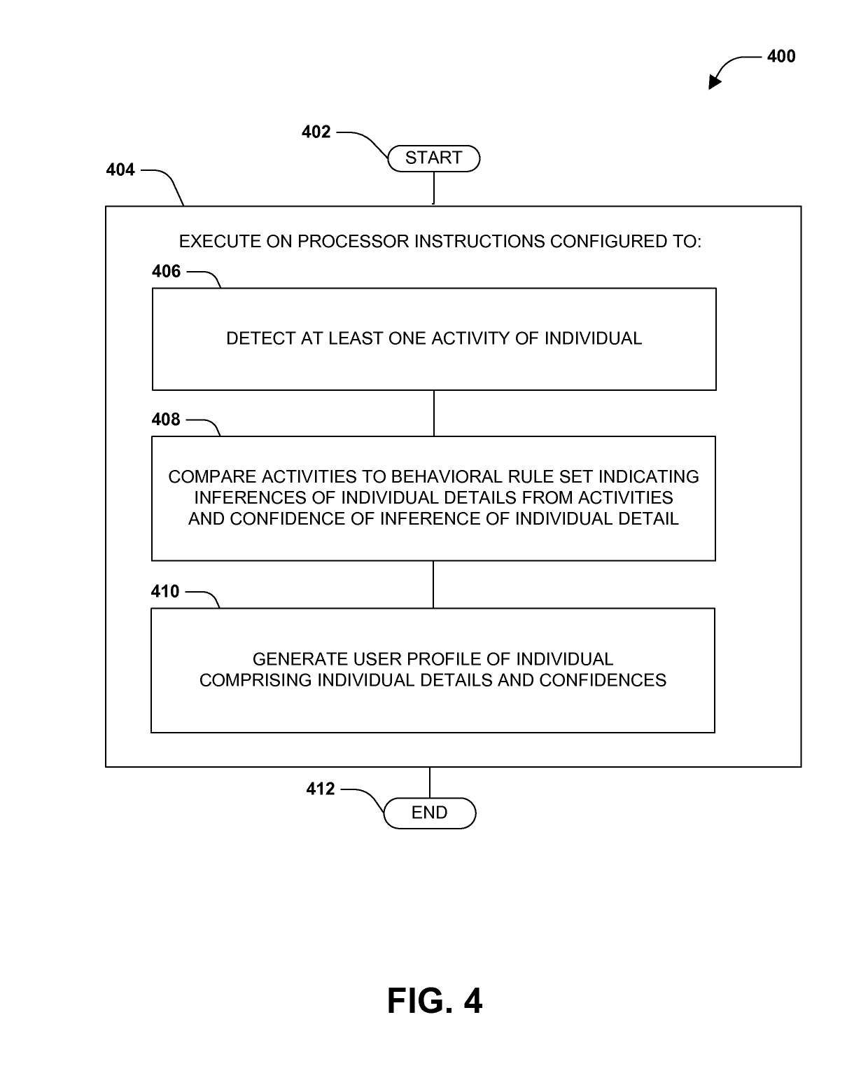

FIG. 4 presents a second exemplary embodiment of the techniques presented herein, illustrated as an exemplary method 400 of generating an individual profile 106 of an individual 102. The exemplary method 400 may be implemented, e.g., as a set of instructions stored in a memory component of a device 302, such as a memory circuit, a platter of a hard disk drive, a solid-state storage device, or a magnetic or optical disc, and organized such that, when executed on a processor 304 of the device 302, cause the device 302 to operate according to the techniques presented herein. The exemplary method 400 begins at 402 and involves executing 404 the instructions on a processor 304 of the device 302. Specifically, the instructions are configured to detect 406 at least one activity 314 of the individual 102 (e.g., by receiving a notification from a sensor 308 that is monitoring the activities 314 of the individual 102). The instructions are also configured to compare 408 the at least one activity 314 of the individual 102 to a behavioral rule set 316 to infer at least one individual detail 222 of the individual 102, and a confidence 224 of the inference 220 of the individual detail 222. The instructions are also configured to generate 410 the individual profile 106 of the individual 102 comprising the respective individual details 222 and the confidence 224 of the inferred individual detail 222. In this manner, the exemplary method 300 achieves the generation of the individual profile 106 of the individual 102 according to inferences 220 of individual details 222 in accordance with the techniques presented herein, and so ends at 412.

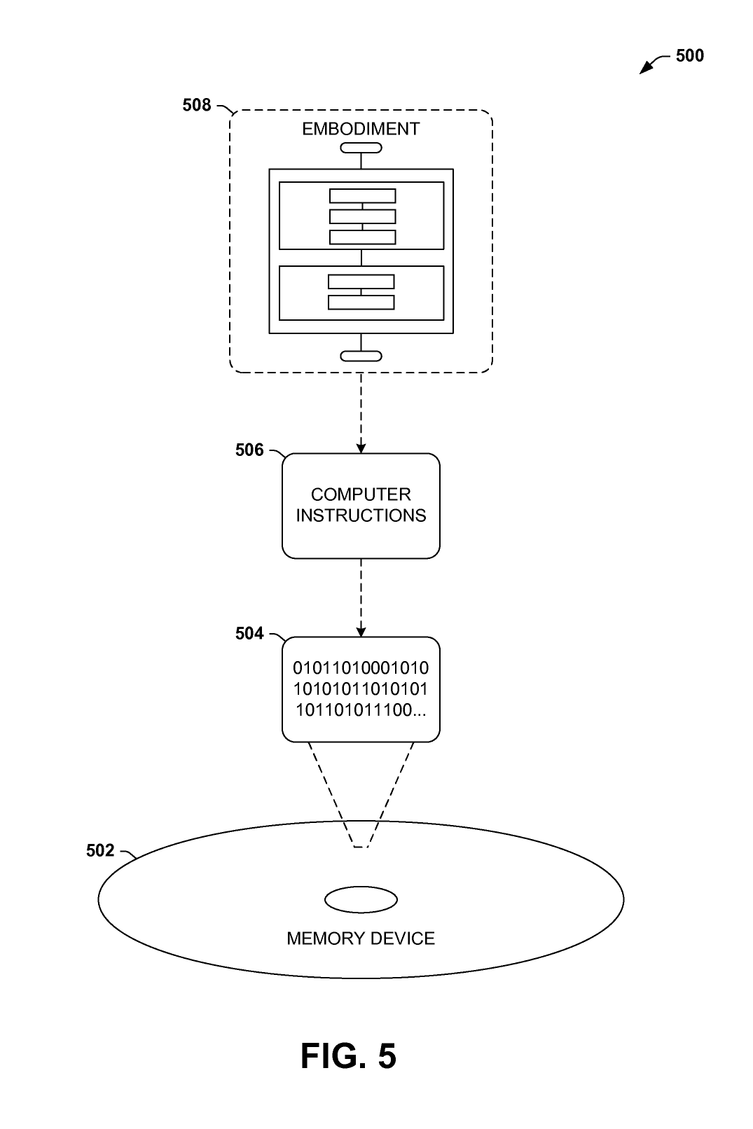

FIG. 5 presents an illustration of an exemplary scenario 500 featuring an exemplary memory device 502 (e.g., a CD-R, DVD-R, or a platter of a hard disk drive), on which is encoded computer-readable data 504. The computer-readable data 504 in turn comprises a set of computer instructions 506 configured to operate according to the principles set forth herein. In one such embodiment, the processor-executable instructions 506 may be configured to implement a system for generating an individual profile 106 of an individual 102, such as the exemplary system 306 of FIG. 3. In another such embodiment, the processor-executable instructions 506 may be configured to perform a method 508 of generating an individual profile 106 of an individual 102, such as the exemplary method 400 of FIG. 4. In a third such embodiment, the processor-executable instructions 506 may be configured to cause a device 302 to generate an individual profile 106 of the individual 102 by monitor the individual 102 to detect at least one activity 314; inferring an individual detail set of the individual 102, comprising at least one individual detail 222 matching the at least one activity 314 of the individual 102 according to the behavioral rule set 316; identify a confidence 224 of the at least one individual detail 222 of the individual 102 inferred from the activity 314; and generate the individual profile 106 of the individual 102 from the individual details 222 having a confidence 224 above a confidence threshold. Many such memory devices may be devised by those of ordinary skill in the art that are configured to operate in accordance with the techniques presented herein.

### D. VARIATIONS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary system 306 of FIG. 3; the exemplary method 400 of FIG. 4; and/or the exemplary memory device 502 of FIG. 2) to confer individual and/or synergistic advantages upon such embodiments.

D1. Scenarios

A first aspect that may vary among embodiments of these techniques relates to the scenarios wherein such techniques may be utilized.

As a first variation of this first aspect, the techniques presented herein may be utilized to achieve the configuration of a variety of devices 104, such as workstations, servers, laptops, tablets, mobile phones, game consoles, portable gaming devices, portable or non-portable media players, media display devices such as televisions, appliances, home automation devices, and supervisory control and data acquisition (SCADA) devices. Part or all of the techniques may be implemented, e.g., on a personal device of the individual 102, and/or on a server, such as a cloud server providing data services to one or more individual 102. A collection of devices may also interoperate to achieve the completion of the techniques presented herein.

As a second variation of this first aspect, many techniques may be utilized to detect the activities 314 of the individual 102. As a first such example, a global positioning system (GPS) receiver may be configured to track the location of the individual 102 over time, which may enable inferences 220 based on the travel history of the individual 102. As a second such example, a physiological monitor may detect various physiological signals from the individual 102, such as heart rate, respiration, and body position and orientation, in order to identify physical activities 314 such as sitting, standing, walking, running, swimming, bicycling, and driving an automobile or boat. As a third such example, a portable device may comprise a set of sensors 308 measuring various properties of the environment while the individual 102 performs various activities 314 (such as accelerometers and gyroscopes measuring the orientation of the device 302; light sensors measuring the ambient light; temperature sensors detecting the ambient temperature; and microphones detecting an ambient noise level and possibly identifying the noise, e.g., as an automobile engine), and may therefore infer the activities 314 of the individual 102. As a fourth such example, a device 302 comprising a camera may utilize a variety of still and/or motion image processing techniques to infer the activities 314 from captured images of the individual 102. As a fifth such example, the device 302 may receive input from the individual 102 or a service (e.g., a calendar managed by the individual 102) indicating one or more activities 314 performed by the individual 102.

As a third variation of this first aspect, the individual profile 106 of the individual 102 may be generated in a general manner, e.g., a comprehensive description of the individual 102. Alternatively, the inferences 220 and selected individual details 222 may be oriented toward a particular type of individual profile 106, such as a demographic individual profile; an academic individual profile; a professional individual profile; a commercial individual profile; or a personality type individual profile. Those of ordinary skill in the art may devise a variety of such scenarios wherein the techniques presented herein may be utilized.

D2. Behavioral Rule Sets and Inferences

A second aspect that may vary among embodiments of the techniques presented herein involves the details of the behavioral rule set 316 and the inferences 220 derived therefrom.

As a first variation of this second aspect, the behavior rule set 316 may be specified as an administrator as a set of logical conditions representing each inference 220, such as an algorithm provided to determine whether a set of location coordinates detected by a location-aware device are likely to support an inference 220 of the residence of the individual 102. Alternatively, the rules of the behavioral rule set 316 may be specified by an administrator as natural-language expression, and one or more natural-language parsing techniques may be applied to derive from the natural-language expression one or more logical conditions enabling the determination of an inference 220 from a set of inputs. For example, a user such as an administrator may provide a natural-language statement specifying an association, such as “if the individual frequently spends weekday evenings at a location, then the location is likely the home of the individual,” and the device 302 may translate this association into logical constraints encoding the inference 220 expressed by the user. Alternatively or additionally, the behavioral rule set 316 may be automatically generated, e.g., by a behavioral rule set evaluator that evaluates a set of individual profiles 106 to identify correlations 318 of individual details 222 with activities 314. Various machine-learning techniques may be utilized for this automated generation of the behavioral rule set 316, including Bayesian classifiers, artificial neural networks, and/or genetic algorithms that are configured to identify statistically consistent patterns in data sets, including the automated generation of inferences 220 of correlations 317 between the activities 314 and individual details 222.

As a second variation of this second aspect, respective rules of the behavioral rule set 316 may specify additional information additional to an activity 314 upon which an inference 220 of an individual detail 222 may be based. Accordingly, a sensor 308 of a device 302 may detect at least one contextual descriptor of a context in which the individual 102 performed at least one activity 314, and compare the activities 314 of the individual 102 with the behavioral rule set 316 particularly in the context associated with the at least one contextual descriptor. As a first such example, if an individual 102 is detected as bicycling to work for several days in a row, some inferences 220 may be applied to determine that the individual 102 has an individual detail 222 involving a bicycling enthusiast. However, detected contextual factors may alter this inference 220, such as a detection of car repairs performed upon an automobile of the individual 102; a closure of a driving road between the home of the individual 102 and the workplace of the individual 102 while a bicycle path remains available; and/or the suspension or termination of a public transportation service utilized by the individual 102, such as the cancellation of a bus or train route. These contextual descriptors may alter the selection of an inference 220, and/or may enable the selection of substitute inferences 220. As a second such example, the determination that the individual 102 is visiting particular locations may be informed with contextual descriptors involving details of the locations retrieved from a location database. For example, if the individual 102 is determined to frequent a particular restaurant, a location data set may provide contextual descriptors indicating a type of cuisine served by the restaurant, thus enabling an inference 220 of the dietary tastes of the individual 102.

As a third variation of this second aspect, the behavioral rule set 316 may specify one or more levels of confidence 224 in respective inferences 220. As a first such example, the confidence 224 may be related to the frequency of the performance of the activity 314; e.g., an activity 314 that is performed occasionally by an individual 102 may be less indicative of an individual detail 222 than an activity 314 that is frequently performed by the individual 102. As a second such example, the confidence 224 may be related to the strength of the correlation 318 between the activity 314 and the individual detail 222. For example, frequently spent weekend evenings in a residence may provide a lower-confidence inference 220 that the residence is the home of the individual 102 than an inference 220 based on frequently spent weekday evenings in a residence (e.g., the residence may be the home of a family member or friend whom the individual 102 frequently visits on weekends). Additionally, some behavioral rule sets 316 may specify several different confidences 224 based on the performance of an activity 314 and the correlation 318 with an individual detail 222. As a first such example, a behavioral rule set 316 may specify, for an activity 314, a first confidence threshold comprising an individual detail likelihood (e.g., an indication that an individual 102 performing the activity 314 at a certain level, such as a first instance count or a first instance frequency, is likely to exhibit the individual detail 222), and also a second confidence threshold comprising an individual detail assurance (e.g., an indication that an individual 102 performing the activity 314 at a higher level, such as a second instance count that is higher than the first instance count or a second instance frequency that is higher than the first instance frequency, is assured to exhibit the individual detail 222).

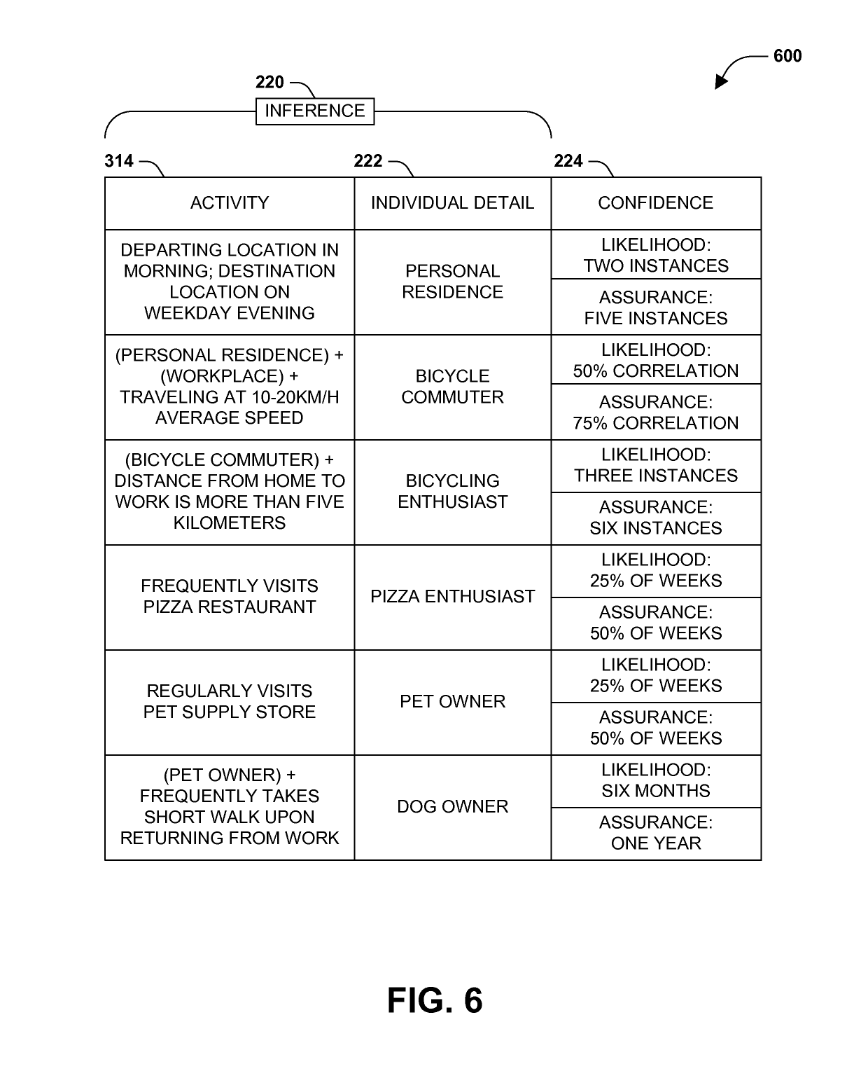

FIG. 6 presents an illustration of an exemplary behavioral rule set 600 specifying a variety of inferences 220 of individual details 222 based on various activities 314. In this exemplary behavioral rule set 600, various activities 314 are specified as a set of conditions that may be detected by a device 302 having one or more sensors 308, optionally with reference to other data sources that may provide contextual descriptors (e.g., the residence of the individual 102 is in an area where, according to a location data set, many of the residents are pet owners). Additionally, some inferences 220 of the exemplary behavioral rule set 600 may be based on individual details 222 identified by other inferences 220; e.g., a first inference 220 that an individual 102 is a pet owner (e.g., because the individual 102 regularly visits a pet supply store) may inform a second inference 220 that the individual 102 is a dog owner (e.g., because the individual 102 exhibits behaviors that are typical of pet owners whose pets are dogs, such as frequently taking a short walk upon returning from work). The exemplary behavioral rule set 600 also specifies two levels of confidence 224 for the respective inferences 220. For example, an individual 102 who travels from home to work on 50% of occasions may be identified as a likely bicycle commuter, while an individual 102 who travels from home to work via bicycle on 75% of occasions may be identified as an assured bicycle commuter. In this manner, the exemplary behavioral rule set 600 may facilitate many types and levels of inferences 220 of the individual details 222 of individuals 102.

As a fourth variation of this second aspect, the individual profile 106 of the individual 102 may include additional sources of information that may supplement the inferences 220 of individual details 222. As a first such example, the individual profile 106 may be supplemented with user input 108; e.g., the device 302 may request the individual 102 to verify an individual detail 222 selected as a result of an inference 220, and may generate the individual profile 106 of the individual 102 including only the individual details 222 that have been verified by the individual 102. As a second such example, the individual profile 106 may include information retrieved from a social profile 118 of the individual 102 provided by a social network 116.

As a fifth variation of this second aspect, the individual profile 106 of the individual 102 may be conditionally updated with some individual details 222 selected by inference 220 from the activities 314 of the individual 102. For example, some inferences 220 may seem likely but not assured. Additional information may later raise the confidence in the inference 220 to a certainty, and the inference 220 may then be added as an individual detail 222 to the individual profile 106.

As a sixth variation of this second aspect, a device 302 may be configured to, after selecting an inference 2220 of an individual detail 222 for an individual 102, continue monitoring the activities 314 of the individual 102 to verify and update the individual profile 106 in view of additional and changing information. As a first such example, an individual 102 may discover a new individual detail 222, such as a new pastime, and the device 302 may detect the new individual detail 222 based on the detection of new activities 314 and new inferences 220 related thereto. As a second such example, an individual detail 222 of an individual 102 may lapse due to changing interests or circumstances, and the device 302 may detect a lapsing by the individual 102 of an activity 314 associated with an individual detail 222 and accordingly reduce the confidence 224 of the individual detail 222 in the individual profile 106 of the individual 102 (e.g., if the individual 102 stops commuting to a workplace via bicycle, the confidence 224 in the inference 220 of the individual 102 as a bicycle commuter may steadily diminish until falling below a threshold, and may then be removed from the individual details 222 of the individual profile 106 of the individual 102 and/or marked as a past individual detail 222). Those of ordinary skill in the art may devise many such inferences 220 and behavioral rule sets 316 in accordance with the techniques presented herein.

D3. Uses of Inferences and Individual Profiles

A third aspect that may vary among embodiments of the techniques presented herein involves various uses of the individual profiles 106 generated through inferences 220 of individual details 222.

As a first variation of this third aspect, an exemplary system 306 may include a product recommendation module that recommends at least one product to the individual 102, where such products are associated with the at least one individual detail 222. For example, the inference 220 that the individual 102 is a bicycle enthusiast may inform the recommendation of products such as bicycling clothing and equipment.

As a second variation of this third aspect, an exemplary system 306 may be utilized in the context of social relationships. For example, a social network may infer that the individual 102 has some hobbies that are similar to those of a second individual, such as inferences that the individuals have an overlapping set of close friends, and may initiate an introduction between the individual 102 and the second individual as members of the same social circle.

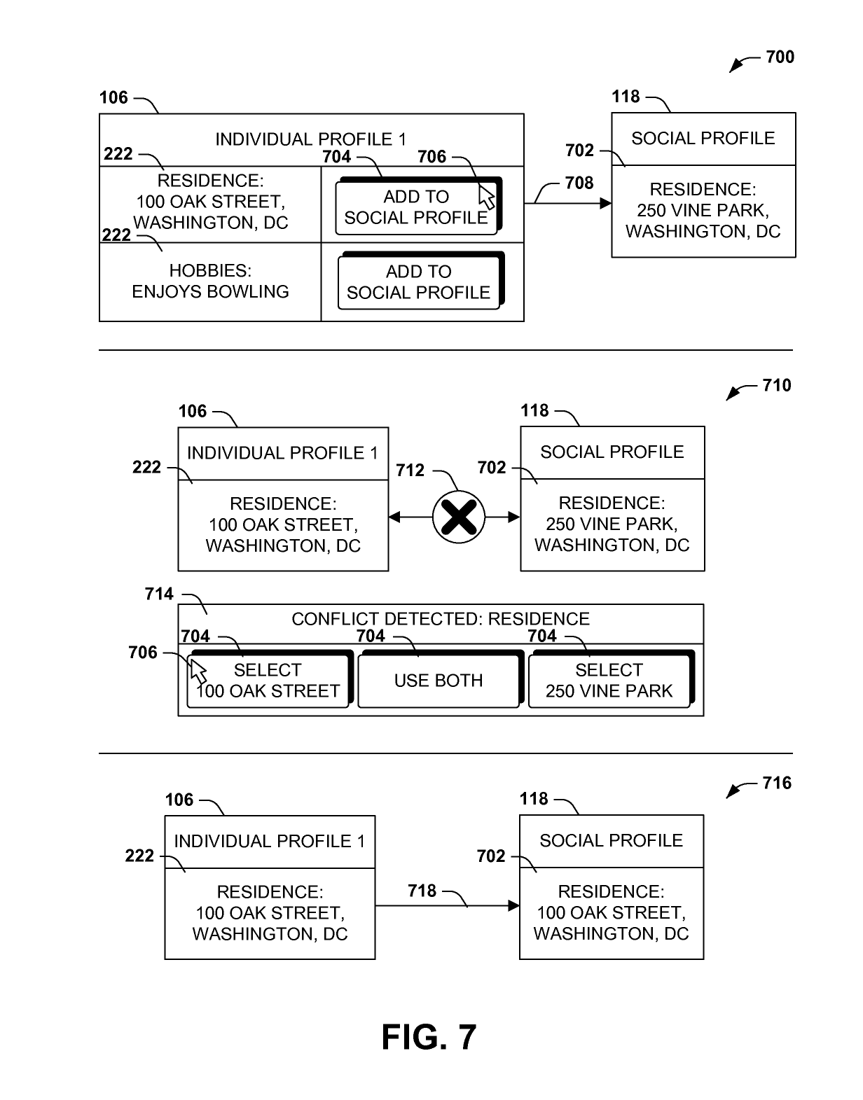

FIG. 7 presents an illustration of an exemplary scenario 700 featuring a third variation of this third aspect, involving the merging of an individual profile 106 and a social profile 118. An exemplary system 306 may include a social network interface that merges at least a portion of the individual profile 106 of the individual 102 with elements 702 of a social profile 118 created by the individual 102 in a social network 116. In this exemplary scenario 700, the device 302 may seek to merge the social profile 118 of the individual 102 with the profile 106 generated by the device 302 through inferences 220. However, respecting the interests of the individual 102 in the privacy of the individual profile 106, it may not be desirable to automatically share the inferences 220 with the social network 116 until receiving the consent of the individual 102; e.g., the user may consent to sharing his or her residential address in a social profile 118, but may wish to keep information about the individual's enjoyment of bowling within the individual profile 106. Accordingly, in furtherance of the privacy of the individual 102, the device 302 may present a set of options 704 permitting the individual 102 to select the individual details 222 to be merged with the elements 702 of the social profile 118 (e.g., only merging 708 the portions of the individual profile 106 that have been authorized for merging by the individual 102, such as by detecting a selection of an option 704 with a pointing device 706). Additionally, while completing the merging 708, the device 302 may detect a conflict 712 between an element 702 of the social profile 118 and an individual detail 222 of the individual profile 106 (e.g., conflicting information about the location of the residence of the individual 102). At a second time 710, the device 302 may present to the individual 102 a notification 714 of the discovered conflict 712, and options 704 for completing the merging 708. Upon detecting a selection of an option 704 with a pointing device 706 indicating a clarification of the conflict 712, the device 302 may complete the merging 708 according to the selected option 704, and, at a third time point 716, may therefore achieve the synchronization 718 of the individual profile 106 and the social profile 118 in accordance with the techniques presented herein.

### E. COMPUTING ENVIRONMENT

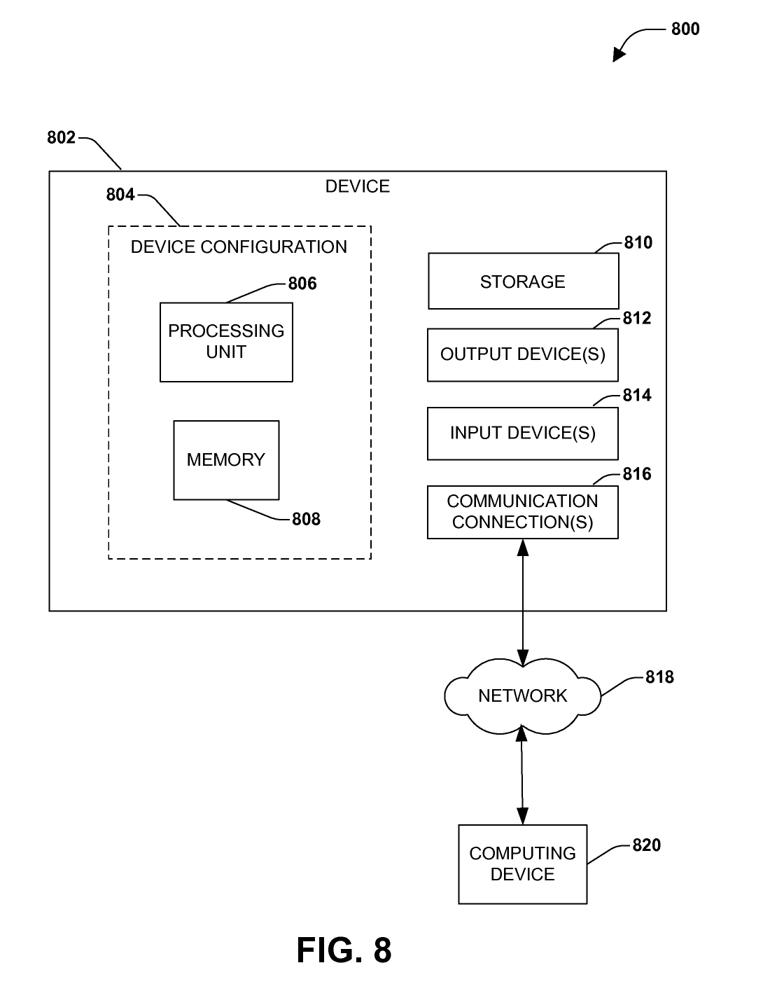

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer-readable instructions” being executed by one or more computing devices. Computer-readable instructions may be distributed via computer-readable media (discussed below). Computer-readable instructions may be implemented as program modules, such as functions, objects, Application Programming Interfaces (APIs), data structures, and the like, that perform particular tasks or implement particular abstract data types. Typically, the functionality of the computer-readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer-readable instructions to implement one or more embodiments provided herein may be in storage 810. Storage 810 may also store other computer-readable instructions to implement an operating system, an application program, and the like. Computer-readable instructions may be loaded in memory 808 for execution by processing unit 806, for example.

The term “computer-readable media” as used herein includes memory devices that, as a class of technology, categorically excludes electromagnetic signals and non-statutory embodiments. Such memory devices may be volatile and/or nonvolatile, removable and/or non-removable, and may involve various types of physical devices storing computer-readable instructions or other data. Examples of such memory devices include RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer-readable media” also includes communication media, as a distinct and mutually exclusive category of computer-readable media than memory devices. Communication media typically embodies computer-readable instructions or other data in a “modulated data signal” such as a carrier wave or other transport mechanism and includes any information delivery media. The term “modulated data signal” may include an electromagnetic signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer-readable instructions may be distributed across a network. For example, a computing device 820 accessible via network 818 may store computer-readable instructions to implement one or more embodiments provided herein. Computing device 802 may access computing device 820 and download a part or all of the computer-readable instructions for execution. Alternatively, computing device 802 may download pieces of the computer-readable instructions, as needed, or some instructions may be executed at computing device 802 and some at computing device 820.

### F. USAGE OF TERMS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer-readable instructions stored on one or more memory devices, where the execution of such instructions by a computing device causes the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for generating an individual profile of an individual on a device having a processor, the system comprising:
at least one sensor that detects at least one activity of the individual;
a individual detail inferrer that infers at least one individual detail of the individual according to the at least one activity and a behavioral rule set; and
an individual profile generator that generates the individual profile comprising the at least one individual detail inferred for the individual.

2. The system of claim 1, further comprising: a product recommendation module that recommends at least one product to the individual associated with the at least one individual detail.

3. The system of claim 1, further comprising: a social network interface that:
identifies a second individual having individual details that are compatible with the individual; and
recommends a social connection between the individual and the second individual.

4. The system of claim 1, further comprising: a social network interface that merges at least a portion of the individual profile of the individual with a social profile created by the individual in a social network.

5. The system of claim 4, wherein the social network interface that merges with the social profile of the individual only a portion of the individual profile authorized for merging by the individual.

6. The system of claim 4, wherein, upon identifying a conflict between an individual detail in the individual profile of the individual and an element of the social profile of the individual, the social network interface:
requests the individual to provide a clarification of the conflict; and
upon receiving the clarification from the individual, updates the individual profile and the social profile according to the clarification.

7. The system of claim 4, further comprising: a behavioral rule set evaluator that:
evaluates a set of individual profiles to identify a correlation of an individual detail with an activity; and
adds to the behavioral rule set at least one inference from the correlation of the activity and the individual detail.

8. A memory device comprising instructions that, when executed on a processor of a computer of an individual, cause the computer to generate an individual profile of the individual by:
monitor the individual to detect at least one activity;
infer an individual detail set of the individual comprising at least one individual detail matching the at least one activity of the individual according to a behavioral rule set;
identify a confidence of the at least one individual detail of the individual and the activity; and
generate the individual profile of the individual from the individual details having a confidence above a confidence threshold.

9. The memory device of claim 8, wherein the computer further comprises:
a first confidence threshold comprising an individual detail likelihood, and
a second confidence threshold comprising an individual detail assurance.

10. The memory device of claim 9, wherein:
the first confidence threshold is associated with a detection of the activity above a first instance count; and
the second confidence threshold is associated with a detection of the activity above a second instance count that is higher than the first instance count.

11. The memory device of claim 9, wherein:
the first confidence threshold is associated with a detection of the activity above a first instance frequency; and
the second confidence threshold is associated with a detection of the activity above a second instance frequency that is higher than the first instance frequency.

12. The memory device of claim 8, wherein executing the instruction further causes the device to, upon detecting a lapsing by the individual of an activity associated with an individual detail, reduce the confidence of the individual detail in the individual profile of the individual.

13. A method of generating an individual profile of an individual on a device having a processor, the method comprising:
executing on the processor instructions that cause the device to:
detect at least one activity of the individual;
compare the at least one activity of the individual to a behavioral rule set indicating an inference of at least one individual detail from at least one activity, and a confidence of the inference of the individual detail; and
generate the individual profile of the individual comprising the respective individual details and the confidence of the individual detail.

14. The method of claim 13, wherein executing the instructions further causes the device to, upon receiving from an individual an association specified in a natural-language expression:
derive at least one inference of an individual detail according to at least one an activity; and
store the at least one inference in the behavioral rule set.

15. The method of claim 13, wherein:
executing the instructions further causes the device to detect at least one contextual descriptor of a context in which the individual performed at least one activity; and
comparing the activity to the behavioral rule set further comprises: comparing the at least one activity of the individual with the behavioral rule set in the context associated with the at least one contextual descriptor.

16. The method of claim 15, wherein:
the contextual descriptor comprises a location type of a location of the individual while performing the at least one activity; and
executing the instructions further causes the device to:
detect the location of the individual while performing the at least one activity; and
access a location data set to identify a location type of the location.

17. The method of claim 13, wherein executing the instructions further causes the device to:
upon inferring an individual detail of the individual, add the individual detail of the individual to an inference profile; and
upon detecting an acknowledgment by the individual of the individual detail, move the individual detail from the inference profile to the individual profile of the individual.

18. The method of claim 17, wherein:
at least one service is associated with the individual detail of the individual; and
the acknowledgment by the individual comprises an interaction of the individual with the service.

19. The method of claim 13, wherein:
executing the instructions further causes the device to, upon inferring an individual detail of the individual, request the individual to verify the individual detail; and
generating the individual profile of the individual further comprises: generating the individual profile of the individual comprising the respective individual details that have been verified by the individual.

20. The method of claim 13, wherein executing the instructions further causes the device to:
according to the at least one individual detail of the individual, identify a personality type of the individual;
retrieve a second behavioral rule set for the personality type of the individual; and
compare the at least one activity of the individual to the second behavioral rule set to infer at least one additional individual detail of the individual.
